(19) United States
(12) Patent Application Publication
(10) Pub. No.: US 2008/0178589 A1
(43) Pub. Date: Jul. 31, 2008

(54) HEAT-PIPE GENERATOR

(75) Inventors: Sin-Wei He, Jhudong Township (TW); Te-Chang Chou, Hukou Township (TW); Liang-Sheng Chang, Hengshan Township (TW); Chin-Ching Ku, Jhudong Township (TW)

Correspondence Address: EGBERT LAW OFFICES, 412 MAIN STREET, 7TH FLOOR, HOUSTON, TX, 77002, US

(73) Assignee: FORCECON TECHNOLOGY Co., Ltd., Chu Pei City (TW)

(21) Appl. No.: 11/750,532

(22) Filed: May 18, 2007

(30) Foreign Application Priority Data
Aug. 7, 2006 (TW) 095128847

(51) Int. Cl. F01K 15/00; F01K 7/16; H02K 37/24

(52) U.S. Cl. 60/531; 60/670; 310/48

(57) ABSTRACT

The present invention provides a heat-pipe generator. The blade is assembled into the heat pipe, a magnetic rotor is arranged around the blade, and generating coils are assembled externally onto the heat pipe opposite to the magnetic rotor. When the working liquid within the heat pipe is evaporated into vapor to drive the blade and the magnetic rotor, the generating coil outside of the heat pipe will yield inductive power, thus maintaining a vacuum state in the heat pipe for heat conduction. The magnetic rotor and generating coils may generate power accordingly.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a heat-pipe generator, and more particularly to an innovative generator with a power generation structure formed within and outside of the heat pipe.

2. Description of Related Art Including Information Disclosed Under 37 CFR 1.97 and 37 CFR 1.98

Heat pipes are widely applied to heat radiation for electronics due to extremely good heat conductivity. Its inner wall is covered with capillary tissue, which contains working liquid with a variable state. The working liquid at one end is evaporated into a gaseous state and transferred to the other end along with heat energy. Then, the working liquid is condensed to flow back into its original position for heat radiation. For this reason, a steam generator has been developed. Referring to FIG. 1 in the U.S. Pat. No. 4,186,559, a turbine blade 15 is mounted into the heat pipe 11. A drive rod 39 is assembled at the rear end of the turbine blade 15. A generator 45 is assembled externally onto the heat pipe 11, and also fitted with a sleeve 25 connected to the turbine blade 15 via the heat pipe 11. A drive rod 43 within the sleeve 25 is linked to a drive rod 39 of the turbine blade 15. When the gaseous working liquid in the heat pipe 11 enters into the turbine blade 15, the drive rod 39 and drive rod 43 are driven forcibly to activate the generator 45.

However, since the sleeve 25 and drive rod 43 of the generator 45 must be linked to the drive rod 39 of turbine blade 15 bypassing through the heat pipe 11, any gap on the heat pipe 11 will make it impossible to form a vacuum state, leading to poorer heat conduction and power generating efficiency of the heat pipe 11.

Thus, to overcome the aforementioned problems of the prior art, it would be an advancement in the art to provide an improved structure that can significantly improve efficacy.

To this end, the inventor has provided the present invention of practicability after deliberate design and evaluation based on years of experience in the production, development and design of related products.

### BRIEF SUMMARY OF THE INVENTION

The present invention permits the blade 2 with magnetic rotor 3 to be placed close to the inner wall of the heat pipe 1. Then, the blade 2 creates a vacuum with the heat pipe 1 to maintain a good heat conduction pattern. Next, some generating coils 4 are arranged close to the heat pipe 1 and opposite the magnetic rotor 3. When the blade 2 and the magnetic rotor 3 are driven by the vapor 13 of working liquid 11, the magnetic rotor 3 allows the generating coil 4 to yield inductive power, thereby achieving excellent heat conduction and power generation efficiency.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a schematic view of power generation of the present invention.

FIG. 2 shows another schematic view of power generating structure of the present invention.

FIG. 3 shows a schematic view of the application of the coil of the present invention.

FIG. 4 shows an assembled schematic view of the blade of the present invention.

FIG. 5 shows another schematic view of the power generating structure of the present invention.

FIG. 6 shows still another schematic view of the application of the magnetic rotor driven by the blade.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

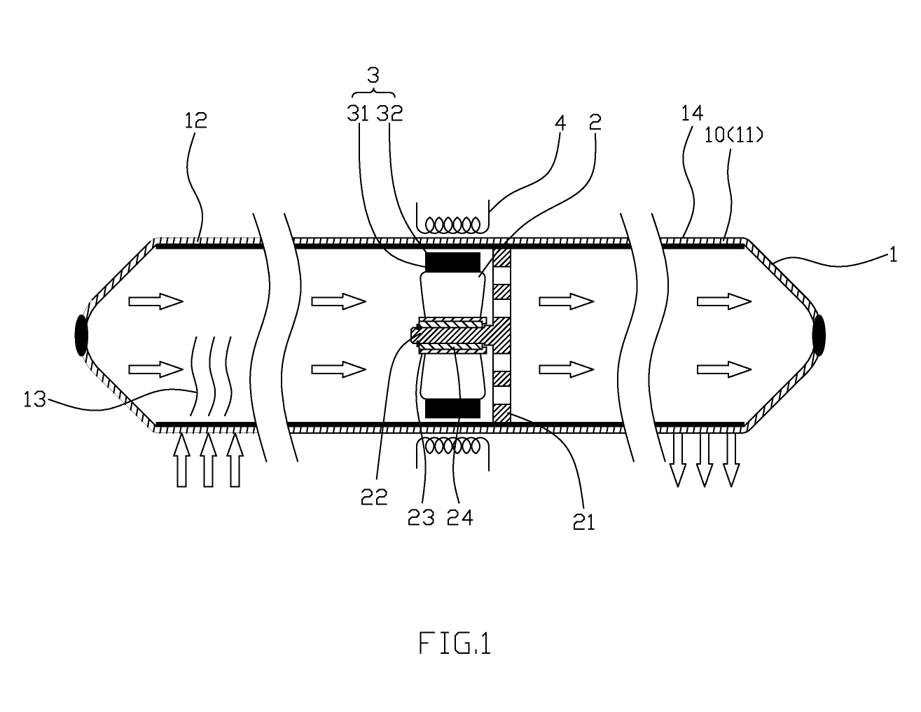

FIG. 1 depicts a preferred embodiment of improved heat-pipe generator of the present invention. The embodiment is provided for only explanatory purposes.

The heat-pipe generator includes a vacuumed heat pipe 1, which is covered with capillary tissue 10 on the inner wall and filled with a little working liquid 11 in a variable state. Referring to FIG. 1, the left end of the heat pipe 1 is a heating end 12. When the heating end 12 is heated up and the working liquid 11 in the capillary tissue 10 is evaporated into vapor 13, the pressure of the left heating end 12 is greater than that of the right cooling end 14, so that the vapor 13 of the working liquid 11 is diffused to the right cooling end 14. Then, the vapor 13 of the working liquid 11 is condensed into liquid state to flow back to the heating end 12.

A blade 2 is assembled between the heating end 12 and cooling end 14 within the heat pipe 1 and also formed on the heat-radiating path of vapor 13 of the working liquid 11. It is fastened securely onto a base 21 within the heat pipe 1. The base 21 is provided with an assembly portion 22 for the blade 2. The blade 2 allows a ceramic bearing 24 of the axle center 23 to be sleeved onto the assembly portion 22, thus providing good lubricating effect during rotation of the blade 2.

A magnetic rotor 3 permits magnet 32 to be arranged around the rotor support 31 in a sector form. In detail, the magnet 32 on the rotor support 31 could be arranged into either a ring shape or a blocky shape. Referring to FIG. 1, the magnetic rotor 3 is assembled around the blade 2 through the rotor support 31, and the magnet 32 is placed close to the heat pipe 1.

A certain amount of generating coils 4 are placed very close to the heat pipe 1 and arranged at interval in a radiative manner. The generating coil 4 is placed opposite to the magnetic rotor 3 of the blade 2 within the heat pipe 1.

When the vapor 13 of working liquid 11 in the heat pipe 1 is diffused from the heating end 12 to the cooling end 14, the blade 2 and the magnetic rotor 3 are driven forcibly to yield shear force of magnetic lines for the generating coil 4, bringing about inductive power generation.

The advantages of the present invention are described below.

A typical power generating structure is separately formed within and outside of the heat pipe, while the power shall be output through the drive rod. In such case, the structural members have to pass through the heat pipe, making it possible to maintain a vacuum state, and leading to poorer heat conduction and power generating efficiency. In the present invention, the blade 2 of the magnetic rotor 3 is fixed close to the heat pipe 1, then the heat pipe 1 is vacuumed to provide a good heat conduction pattern. Then, some generating coils 4 are arranged close to the heat pipe 1 and opposite to the magnetic rotor 3. When the blade 2 and the magnetic rotor 3 are driven by the vapor 13 of working liquid 11, the magnetic rotor 3 allows the generating coil 4 to yield inductive power, thereby achieving excellent heat conduction and power generation efficiency.

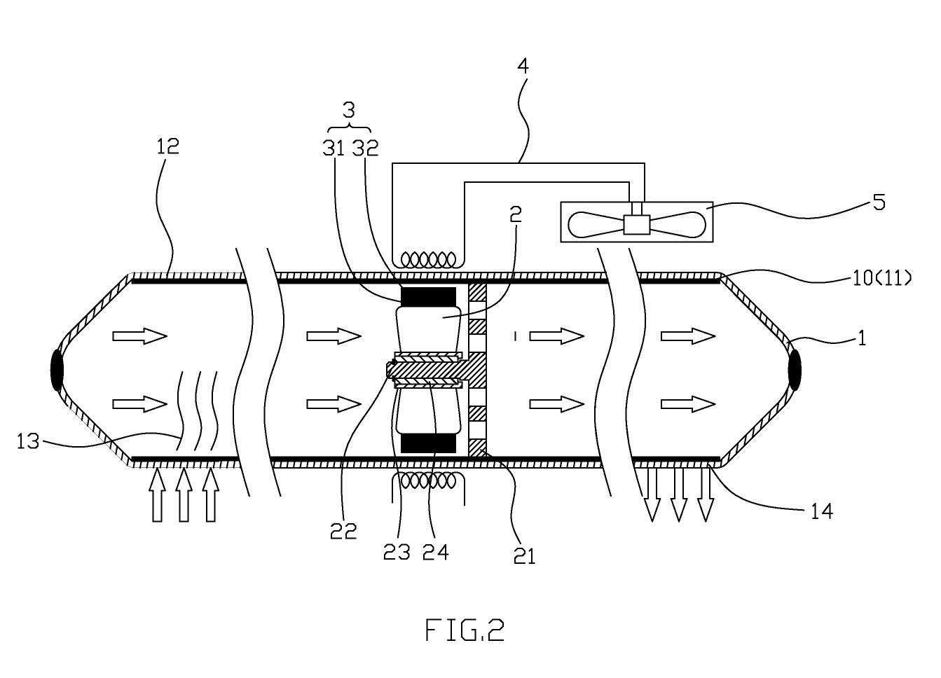

The current from the generating coil 4 is supplied directly to the consumers through the electric wire 41. Referring to FIG. 2, the electric wire 41 is linked to a cooling fan 5, which is used exclusively for the cooling end 14 of the heat pipe 1.

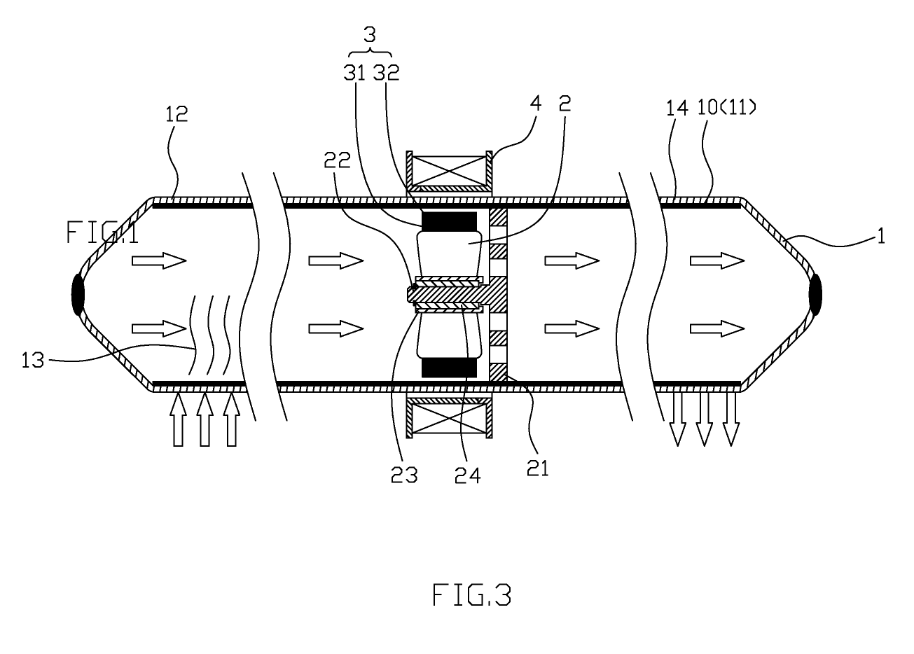

FIG. 3 depicts another application example of the generating coil 4, which is arranged close to the heat pipe 1 in a ring shape.

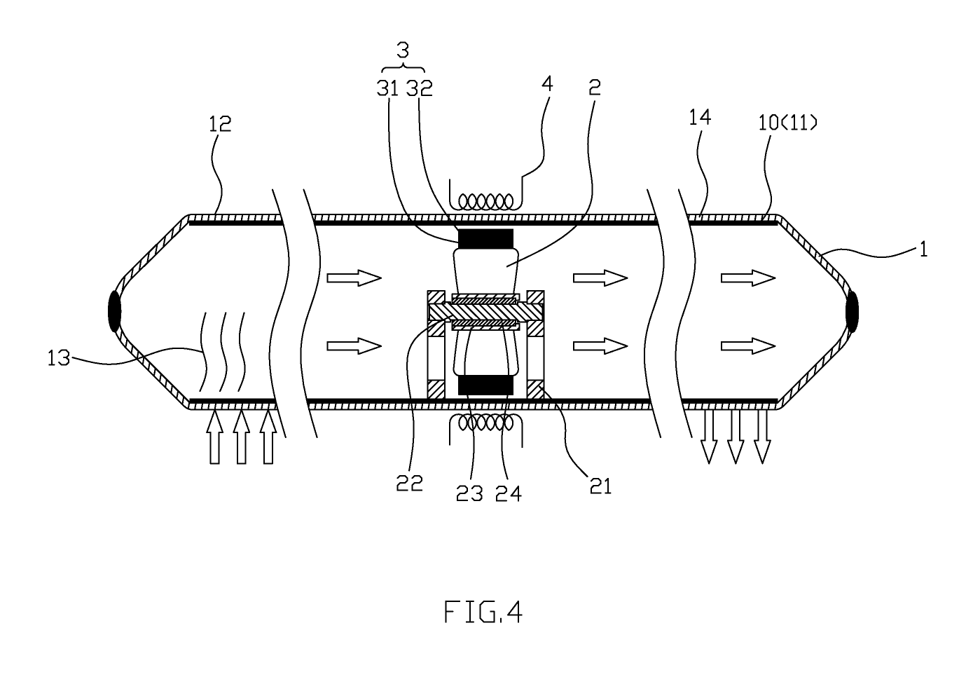

FIG. 4 depicts another application example of the blade 2 in the heat pipe 1, of which the base 21 comprises two bodies extending from one side of the inner wall of heat pipe 1. An assembled portion 22 for the blade 2 is formed between the ends of the basement 21.

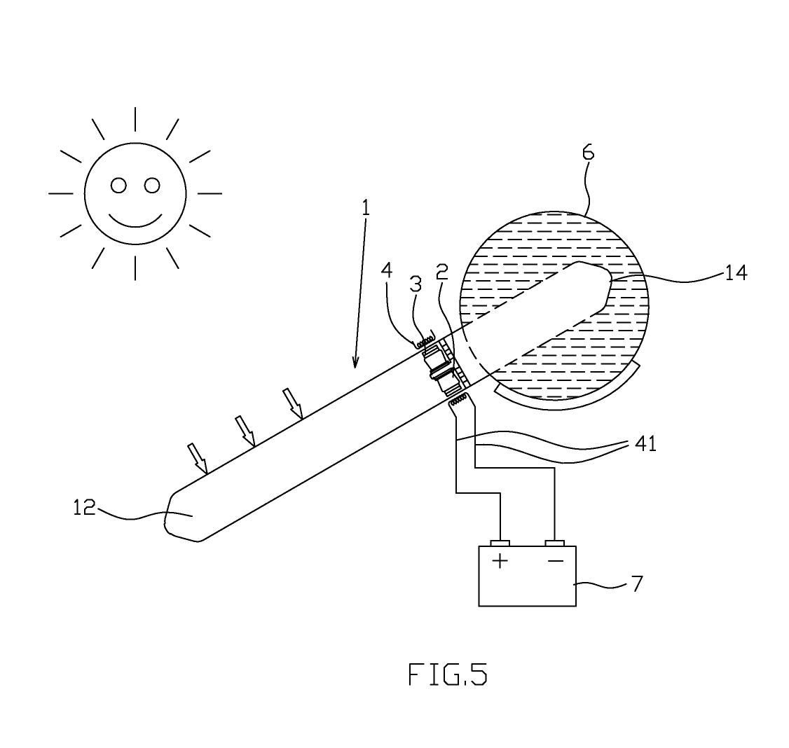

FIG. 5 depicts another application example of the present invention, wherein the heat pipe 1 can be applied to a solar generator and liquid generator. The cooling end 14 of the heat pipe 1 is linked to a water tank 6, which absorbs the heat energy released by the cooling end 14. The current from the generating coil 4 is stored into a fuel cell 7 through a polar line 41.

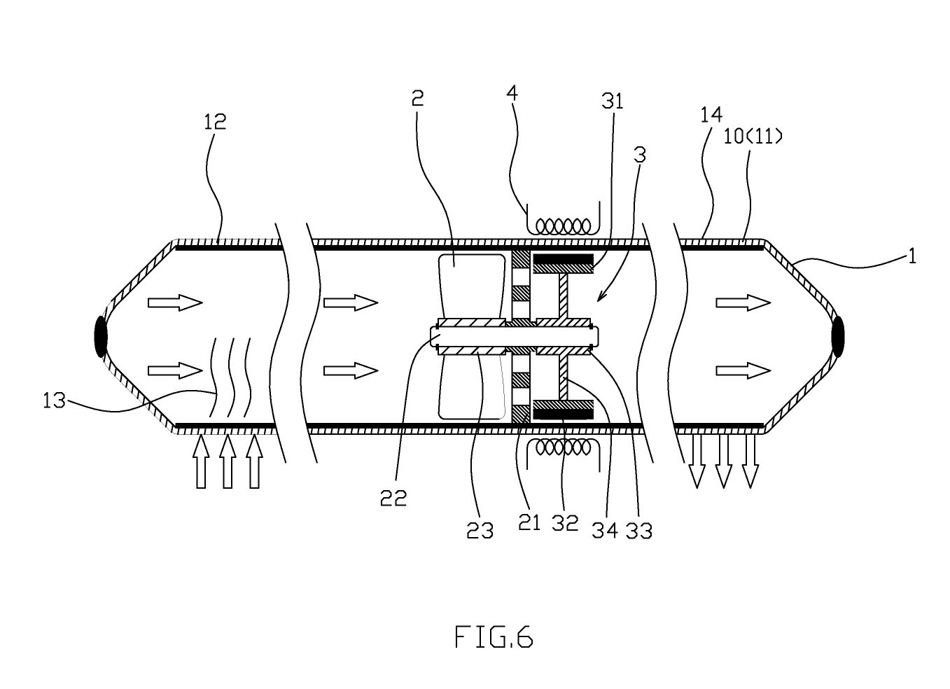

FIG. 6 depicts another application example of the magnetic rotor 3 driven by the blade 2. The rotor support 31 of the magnetic rotor 3 is provided with an axle center 33, from which a support rib 34 is extended externally. The blade 2 is assembled onto the assembly portion 22 at one end of the basement 21, and the assembly portion 22 passes through the base 21 to the other end for assembly of axle center 33 of the magnetic rotor 3, so that the magnetic rotor 3 is driven to rotate along with the blade 2.

1. A heat-pipe generator, comprising:
a vacuumed heat pipe, being filled with a liquid in a variable physical state, said liquid having a heat-radiating path as a vapor;
a blade, being assembled within said heat pipe and placed in said heat-radiating path of said vapor, said blade can being rotatable by said vapor;
a magnetic rotor, having a magnet arranged around a rotor support in a sector form, said magnetic rotor being coupled to said blade and placed in proximity to an inner wall of said heat pipe; and
a generating coil, being placed in proximity to said heat pipe and opposite to said magnetic rotor, inductive power being generated from shear force of magnetic lines.

2. The generator defined in claim 1, wherein said heat pipe is covered with capillary tissue on said inner wall.

3. The generator defined in claim 1, wherein said blade has a ceramic bearing sleeved onto a base of said heat pipe, said base having an assembly portion for said ceramic bearing.

4. The generator defined in claim 1, wherein said magnet of said magnetic rotor is arranged on said rotor support in a ring shape.

5. The generator defined in claim 1, wherein said magnet of said magnetic rotor is arranged on said rotor support in a blocky shape.

6. The generator defined in claim 1, wherein said rotor support of said magnetic rotor is placed around said blade.

7. The generator defined in claim 1, wherein said rotor support of said magnetic rotor is provided with an axle center, said axle center having a support rib extended externally therefrom, said blade being assembled onto an assembly portion at one end of a base of said heat pipe, said assembly portion passing through said base to another end for assembly of said axle center of the magnetic rotor, said magnetic rotor being driven to rotate along with said blade.

8. The generator defined in claim 1, wherein said generating coil is arranged at intervals in a radiative manner.

9. The generator defined in claim 1, wherein said generating coil is arranged externally onto said heat pipe in a ring shape.

10. The generator defined in claim 1, wherein said generating coil has current supplied directly to consumers through electric wire.

11. The generator defined in claim 1, wherein said generating coil has current stored into a fuel cell.
